(19) United States
(12) Patent Application Publication
(10) Pub. No.: US 2007/0151216 A1
(43) Pub. Date: Jul. 5, 2007

(54) Gas filter for oven

(76) Inventor: Daryl Charriere, Hayward, CA (US)

Correspondence Address: BELL & ASSOCIATES, 416 FUNSTON ST., SUITE 100, SAN FRANCISCO, CA, 94118, US

(21) Appl. No.: 11/650,138

(22) Filed: Jan. 4, 2007

Related U.S. Application Data
(60) Provisional application No. 60/756,436, filed on Jan. 4, 2006.

(51) Int. Cl. B01D 46/00

(52) U.S. Cl. 55/483; 55/484

(57) ABSTRACT

The invention is a filter or filter assembly for use in reducing contaminants of powder finishes and preventing buildup of contaminants in powder-curing ovens. The use of such a filter reduces “down-time” and costs incurred for regular cleaning and maintenance of such ovens.

The present application claims priority to U.S. Provisional Patent Application Ser. No. 60/756,436 entitled “Filter Assembly for Powder Curing Oven”, filed Jan. 4, 2006, which is herein incorporated by reference in its entirety for all purposes.

### FIELD OF THE INVENTION

The present invention is a filter and filter system for use in providing essentially cleaned air and/or purified gases for enclosed ovens.

### BACKGROUND OF THE INVENTION

Powder coating is a dry finishing process. Finely ground particles of pigment and resin are electrostatically charged and sprayed onto the products or items to be coated. The products or items are placed in a curing oven. The products or items to be coated are electrically grounded within the work chamber of the oven, so that the electrostatically charged particles adhere to them until melted and fused into a solid coating in the curing oven.

The result is an attractive, durable, and high-quality finish. Unlike liquid paint, no solvents are used, so only negligible amounts of volatile organic compounds (VOCs) are released into the air. In addition, unused or oversprayed powder can be recovered from the chamber, so any waste powder is minimal and can be disposed of easily and safely.

A curing oven comprises a heat source that heats the air or gas in the work chamber. The heat can be delivered using direct means, such as heated air from gas combustion, or indirect means, such as electric heating elements or a heat exchanger that transfers heat from air heated by gas combustion to the work chamber.

The heated air is circulated within the work chamber using a blower system, such as a plug-mounted, belt-driven, 8,600 cubit feet per minute 7½ HP recirculation blower. This type of arrangement supplies heated air through fully adjustable ducts located on each side of the work chamber near the bottom. There is usually a full return sheet above the work chamber to provide excellent temperature uniformity throughout the work chamber. In addition, a roof-mounted powered exhaust blower, complete with a blending tee, is often provided to dilute the products of combustion and any volatiles released during the curing process. The oven can be heated with an ECLIPSE direct-fired burner, rated for 650,000 BTU per hour. The gas train can include modulating gas control and all necessary safety equipment.

Dirt, dust, and other inorganic and organic debris that is pulled into the oven by the blower system not only contaminate the powdered product, but also become attached to the blower system's fan assembly. As the contaminants attach to the fan and to its housing, the efficiency of the blower begins to decrease. Over time, enough particles become attached to the fan, housing and adjustment plate to seriously restrict the airflow into the oven. The blower assembly then needs to be disassembled and cleaned to restore the system's efficiency. This can be a significant expenditure from both “down-time” as well as from reductions in efficiency of heat transfer, resulting in higher energy costs.

There therefore is an unsolved need for a device or means that can be used to partially or fully clean and/or purify the air or gas entering the oven chamber in order to ensure an improved powder coating and reduce overall manufacturing costs.

### PRIOR ART

Various filters and filter systems for cleaning and purifying ambient air or a gas are known. For example, U.S. Pat. No. 6,843,835, issued on Jan. 18, 2005 to Fornai et al., discloses a portable indoor air cleaning apparatus for personal use. The patent notes that concerns around indoor air quality are growing among consumers and in the scientific/medical community. People are increasingly aware that indoor air pollution can be responsible both for short-term health effects such as eye irritation, headache, breathing problems, allergies, and for serious diseases like chronic respiratory syndromes. The patent claims an air cleaning apparatus having an inlet for ambient air; an outlet for purified air; a mechanism for the uptake of a scrubbing liquor and for the removal of impurities dissolved or dispersed in the ambient air by contact with said scrubbing liquor; an inlet for feeding a scrubbing liquor from a scrubbing liquor feeding tank (wherein said scrubbing liquor comprises a non-evaporative liquid that is able to remove at least some volatile organic compounds and gaseous pollutants from ambient air containing such pollutants); an outlet for discharging used scrubbing liquor; and a blower for drawing ambient air into the apparatus, flowing the air through the apparatus and discharging the purified air from the apparatus comprising an inlet filter located before the uptake and removal means, to remove particles contained in the ambient air. Furthermore, the patent claims an apparatus further comprising an outlet filter immediately before the outlet for purified air to remove a majority of particles in the air stream of the apparatus; and wherein the outlet filter is a mechanical filter of HEPA, ULPA or electret type, optionally combined with an activated carbon, zeolite, or other adsorbent filter. Fornai et al. do not claim nor disclose use in or combined with an oven or the like.

U.S. Pat. No. 6,352,578 to Sakata et al., issued Mar. 5, 2002, relates to an air filter used in a high efficiency air cleaning apparatus, such as a clean room, a clean bench, a storage means (stocker), etc., for removing gaseous inorganic and/or organic impurities contained in the atmosphere in the high efficiency air cleaning apparatus. Sakata et al. do not claim nor disclose use in or combined with an oven or the like.

U.S. Pat. No. 6,238,467 to Azarian et al., issued May 29, 2001, relates to a device for filtering particulates and vapor phase contaminants from a confined environment such as electronic or optical devices susceptible to contamination (e.g., computer disk drives). Azarian et al. do not claim nor disclose use in or combined with an oven or the like.

None of the above inventions and patents, taken either singularly or in combination, is seen to describe the instant invention as claimed. Thus a filter means for removing particulates and other compounds from the air entering a powder-coating oven is desired.

### SUMMARY OF THE INVENTION

The present invention provides a filter for removing contaminants from ambient air or a gas prior to entering an enclosure.

The invention provides a filter adapted for removing particulate and vapor phase contaminants prior to entering an enclosure, the filter comprising: a rigid frame comprising a first side having an opening and a second side having an opening and at least one third side, said side including at least one opening therein and the rigid frame defining a volume therein; at least one first filter media covering the opening in the first side and at least one second filter media covering the opening in the second side, thereby enclosing said volume within the rigid frame to form a chamber. In a preferred embodiment, the at least one first filter media and the at least one second filter media are positioned not parallel to one another. In a more preferred embodiment, the at least one first filter media and the at least one second filter media are positioned perpendicular to one another.

In one embodiment the invention provides a filter adapted for removing particulate and vapor phase contaminants prior to entering an enclosure, the filter comprising: a rigid frame comprising a first end having an opening and a second end having an opening and at least one side, the rigid frame defining a volume therein; a second side extending adjacent to said rigid frame, the second side including at least one opening therein; at least one first filter media covering the opening in the first end and at least one second filter media covering the opening in the second side, thereby enclosing said volume within the rigid frame to form a chamber. In a preferred embodiment, said at least one side comprises multiple sides. In a preferred embodiment the filter further comprises an inlet hole in the at least one side. In another preferred embodiment the filter further comprises a diffusion tube aligned within said inlet hole. In yet another preferred embodiment, said second side is contiguous with and extends in a plane parallel to at least one of the sides. In another preferred embodiment, the filter further comprises a gasket surrounding said diffusion tube.

In a preferred embodiment the rigid frame of the filter comprises at least one material selected from the group consisting of polycarbonate, polypropylene, acrylic, epoxy resin, sheet metal, aluminum, stainless steel, brass, alumina, glass, and reinforced epoxy resin. In a more preferred embodiment the rigid frame comprises sheet metal.

In another preferred embodiment the side comprises at least one material selected from the group consisting of polycarbonate, polypropylene, acrylic, epoxy resin, sheet metal, aluminum, stainless steel, brass, alumina, glass, and reinforced epoxy resin. In a more preferred embodiment the side comprises sheet metal.

In one alternative embodiment, said first filter media and said second filter media have the same properties. In an alternative embodiment said first filter media and said second filter media have different properties. The properties can be selected from the group consisting of filter media size, filter media material, filter media composition, filter media aperture size, filter media pore size, and the like.

In one embodiment said at least one first filter media comprises at least one material selected from the group consisting of papers, membranes, nonwovens, scrims, and cast polymeric membranes. In an alternative embodiment, said at least one first filter media comprises at least one material selected from the group consisting of expanded polytetrafluoroethylene, polypropylene, polyethylene, and polyester. In a yet further alternative embodiment, said at least one first filter media comprises an electret filter media.

In another alternative embodiment, said at least one second filter media comprises at least one material selected from the group consisting of papers, membranes, nonwovens, scrims, and cast polymeric membranes. In an alternative embodiment, said at least one second filter media comprises at least one material selected from the group consisting of expanded polytetrafluoroethylene, polypropylene, polyethylene, and polyester. In a yet further alternative embodiment, said at least one second filter media comprises an electret filter media.

In another embodiment of the invention the filter further comprises a gasket attached to said filter for sealing the enclosure with the filter. In another embodiment, said rigid frame includes a venturi within said chamber. In a yet further embodiment, said rigid frame further comprises a vane adapted for deflecting airflow within the chamber.

In another alternative embodiment the filter further comprises an attachment means for attaching said filter to said enclosure, the attachment means selected from the group consisting of an adhesive, a drop-in-place assembly, a lock-in-place assembly, and a pressure fit gasket assembly.

The invention further provides an article comprising a filter adapted for removing particulate and vapor phase contaminants prior to entering an enclosure, the article comprising: a rigid three-dimensional frame having substantially the form of a parallelogram comprising: a first open end and a second open end, each opening having a top edge, a bottom edge and two side edges; a bottom; two sides, at least one side having an opening therein; and a top therein connecting the two open ends; at least one first filter media covering the opening in the first end and at least one second filter media covering the opening in the side, thereby enclosing said volume within the rigid frame to form a chamber. In a preferred embodiment the filter further comprises an inlet hole in the at least one side. In a preferred embodiment, said at least one side comprises multiple sides. In another preferred embodiment the filter further comprises a diffusion tube aligned within said inlet hole. In yet another preferred embodiment, said side is contiguous with and extends in a plane parallel to at least one of the sides. In another preferred embodiment, the filter further comprises a gasket surrounding said diffusion tube.

In a preferred embodiment the rigid three-dimensional frame of the article comprises at least one material selected from the group consisting of polycarbonate, polypropylene, acrylic, epoxy resin, sheet metal, aluminum, stainless steel, brass, alumina, glass, and reinforced epoxy resin. In a more preferred embodiment the rigid three-dimensional frame comprises sheet metal.

In another preferred embodiment the side of the article comprises at least one material selected from the group consisting of polycarbonate, polypropylene, acrylic, epoxy resin, sheet metal, aluminum, stainless steel, brass, alumina, glass, and reinforced epoxy resin. In a more preferred embodiment the rigid three-dimensional frame comprises sheet metal.

In one alternative embodiment, said first filter media and said second filter media have the same properties. In an alternative embodiment said first filter media and said second filter media have different properties.

In one embodiment said at least one first filter media comprises at least one material selected from the group consisting of papers, membranes, nonwovens, scrims, and cast polymeric membranes. In an alternative embodiment, said at least one first filter media comprises at least one material selected from the group consisting of expanded polytetrafluoroethylene, polypropylene, polyethylene, and polyester. In a yet further alternative embodiment, said at least one first filter media comprises an electret filter media.

In another alternative embodiment, said at least one second filter media comprises at least one material selected from the group consisting of papers, membranes, nonwovens, scrims, and cast polymeric membranes. In an alternative embodiment, said at least one second filter media comprises at least one material selected from the group consisting of expanded polytetrafluoroethylene, polypropylene, polyethylene, and polyester. In a yet further alternative embodiment, said at least one second filter media comprises an electret filter media.

In another embodiment of the invention the article further comprises a gasket attached to said filter for sealing the enclosure with the filter. In another embodiment, said rigid three-dimensional frame includes a venturi within said chamber. In a yet further embodiment, said rigid three-dimensional frame further comprises a vane adapted for deflecting airflow within the chamber.

In another alternative embodiment the article further comprises an attachment means for attaching said article to said enclosure, the attachment means selected from the group consisting of an adhesive, a drop-in-place assembly, a lock-in-place assembly, and a pressure fit gasket assembly.

The invention provides a method for cleaning a gas or fluid prior to entry of the gas or fluid into an enclosure, the method comprising the steps of: (i) providing a filter as disclosed herein, (ii) attaching said filter to a surface of the enclosure proximal to an inlet to the enclosure, said filter in fluid communication with the inlet to the enclosure, (iii) providing a fluid pump system proximal and in fluid communication with the enclosure, (iv) allowing a gas or fluid to be drawn through the inlet thereby drawing the gas or fluid through the filter, the method thereby cleaning the gas or fluid prior to entry into the enclosure.

### BRIEF DESCRIPTION OF THE FIGURES

FIG. 1 illustrates one embodiment of the invention in a three-quarters perspective view without the filter media in position.

FIG. 2 illustrates the filter in plan perspective view, showing the movement of air (arrows) through the filter and combustion chamber.

FIG. 3 illustrates one embodiment of the invention in a three-quarters perspective view showing the filter media in position

FIG. 4 illustrates a horizontal perspective view showing an exemplary arrangement of the diffusion tube, the gasket, and the adjustment plate in place.

FIG. 5 illustrates a three-quarters perspective view showing an exemplary arrangement of the blower fan, the diffusion tube, the gasket, and the adjustment plate in relation to the second end opening.

FIG. 6 illustrates an alternative embodiment of the invention in a three-quarters perspective view showing the positioning of the opening to an enclosure (not shown) and the upper and lower sides.

FIG. 7 illustrates the alternative embodiment of the invention in a three-quarters perspective view showing two filter media in position, perpendicular to one another.

### DETAILED DESCRIPTION OF THE INVENTION

The embodiments disclosed in this document are illustrative and exemplary and are not meant to limit the invention. Other embodiments can be utilized and structural changes can be made without departing from the scope of the claims of the present invention.

As used herein and in the appended claims, the singular forms “a,” “an,” and “the” include plural reference unless the context clearly dictates otherwise. Thus, for example, a reference to “a filter” includes a plurality of such filters, and a reference to “a gas” is a reference to one or more gases and equivalents thereof, and so forth.

The filter is designed to protect the powdered product and the oven's burner system blower from contamination caused by dirt, dust and other debris that is pulled into the oven by the blower.

The filter can be shaped and adapted for positioning and placement upon or adjacent to any article or device. For example, the shape of the filter can be cubic, it can be cuboid, it can be oblong, it can be triangular, it can be a pyramid, it can be spherical, it can be round, it can be a polygon, it can be rhomboid, or the like. The filter can be modular. The filter can comprise modular parts and/or units. The article or device preferably comprises an enclosure within which a process is performed. The article or device process can be a process selected from the group consisting of powder coating, spray painting, injection molding, firing of ceramics and/or glasses, heating of metals and/or alloys, smelting of metals and/or alloys, forging of metals and/or alloys, annealing of metals and/or alloys, clean-room air filtration, environmental hazard filtration, distillation of organic solvents, milling and grinding of minerals, etc., roll compacting, and the like. The article or device can be an article or device selected from the group consisting of an oven, a furnace, an arc reactor, a plasma reactor, a compactor, a bassinette, a fume-hood, a cell-culture hood, a tissue-culture hood, a biological safety cabinet, a biological incubator, a clean room, a still, a computer, a video display unit, an electron microscope, a confocal microscope, a liquid handling system, a motor vehicle, a boat, an aircraft, a space-craft, a submarine, a decontamination room and/or unit, a greenhouse, and the like.

The filter media can be shaped and adapted for ease of removing and replacing in the filter or apparatus, such that the filter media can be cleaned, scrubbed, or the like, in order to remove the contaminants. The filter media can be modular. The filter media can be disposable. The filter media can be biodegradable. The filter media can comprise a compound that biodegrades the contaminants so that the filter media has a longer working life in situ. The filter media can be shaped and adapted according to any one of the following designs or shapes: flat screen, louvered screen, double-louvered screen, fine mesh screen, concave screen, convex screen, and the like.

In one alternative, the article or filter according to the invention comprises an inlet filter, preferably a mechanical filter, any other type of particulate filter can be applied however, immediately before the cleaning filter media to eliminate larger particles contained in the ambient air, for example particles above 10-100 μm or more, which may cause a clogging of the cleaning filter media. Also, the apparatus can comprise one or more outlet filters immediately before the outlet for purified air to eliminate smaller solid particles and/or liquid droplets such as below 5-10 μm or even sub-micron particles contained in the purified air, for example particles below 0.3 μm. The filter can comprise materials that bind to and/or adsorb organic compounds, such as aromatic ring compounds, such as phenol, benzene, or the like; hydrocarbons, such as short chain and long chain hydrocarbons; organic compounds, such as methane, propane, or the like; inorganic compounds, such as metal salts; or the like. Other suitable filters for removing particulate matter include, for example, fiberglass filters, electrostatic filters and non-woven filters, for example of HEPA or ULPA type.

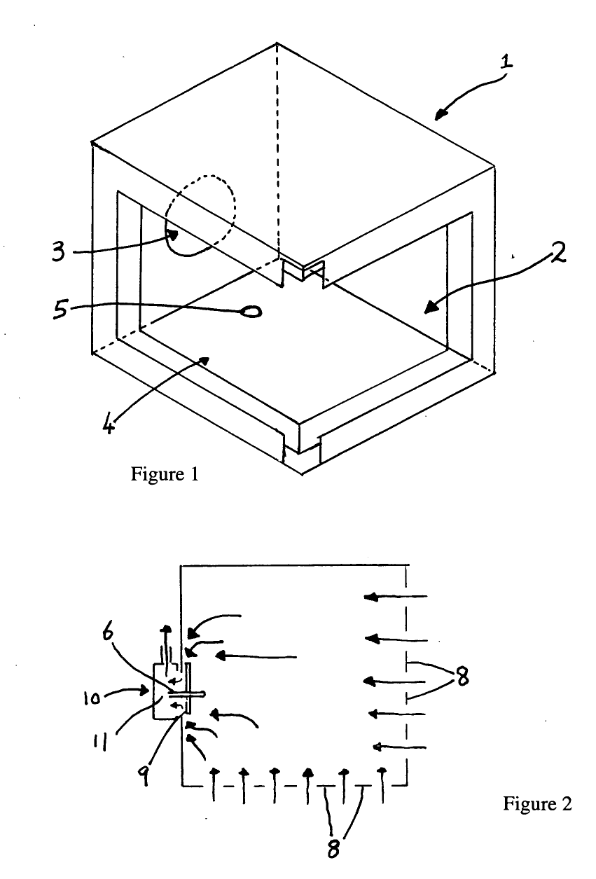

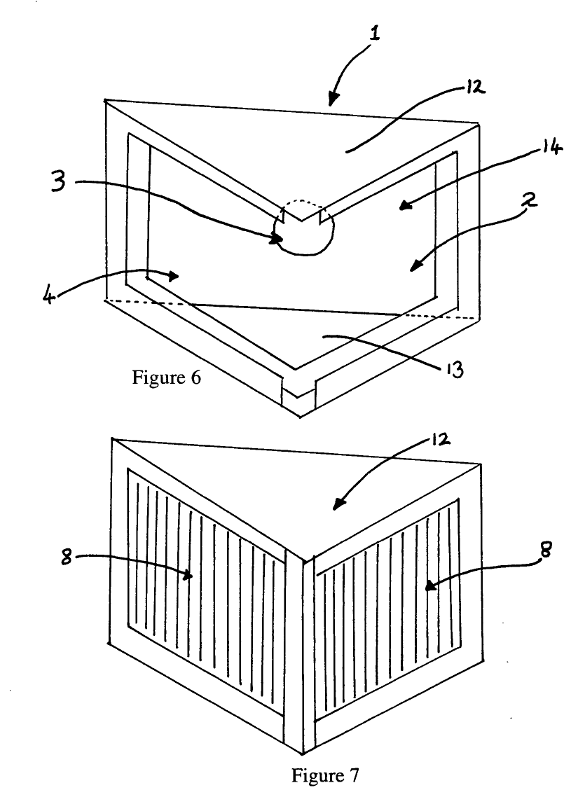

As shown in FIG. 1, FIG. 2, FIG. 4, and FIG. 5, the invention is a filter 1 having two filter media 8, positioned perpendicular to one another. The combination of the two filter media results in an increased relative surface area for filtering the air (filtration area) compared with a filter comprising a single filter media having similar dimensions. The filter media 8 is positioned to cover the inlet opening 2 and/or 4, through which contaminated or unclean air is passed (arrows). The filter further comprises an outlet opening 3, through which the cleaned air passes into the enclosure 11, and, optionally, an inlet hole 5, through which a diffusion tube 6 can be passed. The diffusion tube 6 can be a vacuum-sensing tube in fluid communication to a sensor that detects the presence of absence of a vacuum within the enclosure. The sensor can be in electronic connection to a switch that opens or closes a heat-providing element or device, such as a gas burner, an electrical heating element, a heat exchanger, a battery, a solar panel, a chemical combustion system, a biological heat system, or the like. The diffusion tube 6 is in fluid communication with the enclosure 11 via an aperture in the adjustment plate 9.

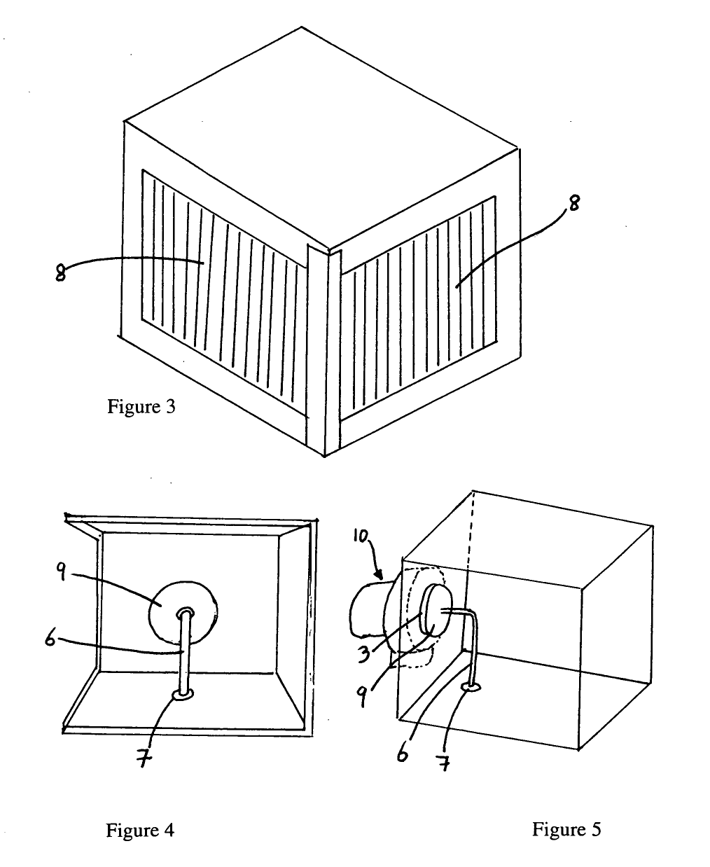

FIG. 3 illustrates the filter media 8 in place upon the filter. The dimensions of the filter media 8 can be from two inches to about sixty inches on each side, for example, from about 2 inches, about 2.5 inches, about 3 inches, about 3.5 inches, about 4 inches, about 4.6 inches, about 5 inches, about 6 inches, about 7 inches, about 8 inches, about 9 inches, about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 33 inches, about 36 inches, about 40 inches, about 44 inches, about 48 inches, about 50 inches, about 55 inches, about 60 inches, any other measurement therebetween, any combination thereof, or any other standard filter media size. In the alternative, the filter media can be from about five centimeters to about two hundred and fifty centimeters on each side, for example, from about 5 cm, about 7.5 cm, about 10 cm, about 15 cm, about 20 cm, about 25 cm, about 30 cm, about 40 cm, about 50 cm, about 62.5 cm, about 75 cm, about 87.5 cm, about 100 cm, about 112.5 cm, about 125 cm, about 150 cm, about 175 cm, about 200 cm, about 225 cm, about 250 cm, any other measurement therebetween, any combination thereof, or any other metric size. In a preferred embodiment the filter media have dimensions of about 16×16 inches or about 40×40 cm.

As disclosed above, the filter media can comprise a material having filtering apertures of dimensions below about 0.3 μm; in the alternative the filtering apertures have dimension of above about 0.3 μm, for example, about 0.5 μm, about 0.75 μm, about 1 μm, about 2 μm, about 3 μm, about 4 μm, about 5 μm, about 10 μm, about 15 μm, about 20 μm, about 25 μm, about 30 μm, about 40 μm, about 50 μm, 60 μm, 75 μm, and 100 μm. In ovens that are susceptible to contamination by particulates of dimensions in the range above 100 μm, filter media having filtering apertures having dimensions of between about 100 μm and about 1 mm are preferred, for example filtering apertures having dimensions of about 100 μm, about 150 μm, about 200 μm, about 300 μm, about 400 μm, about 500 μm, about 600 μm, about 700 μm, about 800 μm, about 900 μm and about 1 mm.

FIG. 4 illustrates an exemplary side view of the filter showing the diffusion tube 6, the gasket 7, and the adjustment plate 9 in place. FIG. 5 illustrates an exemplary three quarter perspective view of the filter showing the diffusion tube 6, the gasket 7, the adjustment plate 9 in place adjacent to the second end opening 3, and the blower fan and motor housing 10 attached to the filter. In use, the blower fan housing also comprises a gas line through which as combustible gas, such as methane or propane, is provided. The blower motor forces ambient air into the enclosure, mixing with the air with the gas and the mixture is ignited by a spark plug located between the blower and the enclosure.

The filter can be cube-shaped and can be mounted directly to the burner's blower housing 10 and can be supported by a bracket that connects the bottom of the filter to a wall of the oven. It can be made of sheet metal. The filter provides for easy inspection and replacement of the air filter media. Control of air entering the blower is accomplished by temporarily removing one of the filter media and rotating the adjustment plate 9 while observing the flame though an inspection port in housing 10. Removing the filter media temporarily is not anticipated to allow significant amounts of contaminants to enter the oven during routine and normal use. The inspection port allows the flame to be viewed by an operator as it enters the oven while adjusting plate 9 to obtain a flame with the correct colors and thus obtaining an efficient air/fuel mixture for the process in hand. The center of the adjustment plate 9 can be threaded. The adjustment plate can be screwed onto a hollow externally-threaded tube that attaches to vacuum-sensing tube 6.

The filter can be installed on a new oven or one that is already in service. It provides a more efficient burner system that will reduce consumption of fuel by a user. It greatly extends the service interval of disassembling and cleaning of the blower assembly. It is a labor-saving device in that it reduces the overall time spent by a user to clean the oven and ancillary systems. It benefits a user from product contamination resulting in a higher quality product and resulting commercial success. The filter media are easily accessed for inspection or replacement thereof by a user. The filter media can comprise any combination of the materials disclosed herein.

FIGS. 6 and 7 illustrate an exemplary alternative embodiment of the invention comprising a triangular-shaped filter that can be placed adjacent to an aperture of an oven, enclosure, or the like. The blower fan and ancillary systems can be positioned within the confines of the oven or enclosure thereby reducing the need for multiple or several sealing means between the filter, the oven or enclosure, and the blower fan housing, etc. As disclosed above, the filter can also be shaped for use with any oven or enclosure, such as a cube, a sphere, a round or circular shape, a pyramidal shape, a triangular shape, or an oblong shape.

Means for testing the efficiency of the filter for adsorbing particulates and other fine particulate matter are well known to those of skill in the art. For example, testing means include measuring the number of particles in a pre-filtered air sample compared with those measured in a heated air sample. Other means for testing can include testing using volatile organic compounds artificially introduced into a sample and comparing the levels of said volatile organic compounds in a sample after filtration. For testing methods, see U.S. Pat. No. 6,238,467, herein incorporated by reference in its entirety.

### LIST OF REFERENCE NUMERALS

1. Filter
2. First End Opening
3. Second End Opening
4. Side Opening
5. Inlet Hole
6. Diffusion Tube
7. Gasket
8. Filter Media
9. Adjustment Plate
10. Blower Fan Housing and Motor
11. Enclosure (Combustion Chamber)
12. Upper Side
13. Lower Side
14. Side

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

I claim:

1. A filter adapted for removing particulate and vapor phase contaminants prior to entering an enclosure, the filter comprising:
a rigid frame comprising a first end having an opening and a second end having an opening and at least one side, the rigid frame defining a volume therein;
a second side extending adjacent to said rigid frame, the second side including at least one opening therein;
at least one first filter media covering the opening in the first end and at least one second filter media covering the opening in the second side, thereby enclosing said volume within the rigid frame to form a chamber.

2. The filter of claim 1, further comprising an inlet hole in the at least one side.

3. The filter of claim 2, further comprising a diffusion tube aligned within said inlet hole.

4. The filter of claim 2, wherein said filter further comprises a gasket surrounding said diffusion tube.

5. The filter of claim 1, wherein said rigid frame comprises at least one material selected from the group consisting of polycarbonate, polypropylene, acrylic, epoxy resin, sheet metal, aluminum, stainless steel, brass, alumina, glass, and reinforced epoxy resin.

6. The filter of claim 5, wherein said rigid frame comprises sheet metal.

7. The filter of claim 1, wherein said at least one side comprises multiple sides.

8. The filter of claim 1 wherein second said side is contiguous with and extends in a plane parallel to at least one of the sides.

9. The filter of claim 1, wherein said side comprises at least one material selected from the group consisting of polycarbonate, polypropylene, acrylic, epoxy resin, sheet metal, aluminum, stainless steel, brass, alumina, glass, and reinforced epoxy resin.

10. The filter of claim 1, wherein said first filter media and said second filter media have the same properties.

11. The filter of claim 1, wherein said first filter media and said second filter media have different properties.

12. The filter of claim 1, wherein said at least one first filter media comprises at least one material selected from the group consisting of papers, membranes, nonwovens, scrims, and cast polymeric membranes.

13. The filter of claim 1, wherein said at least one first filter media comprises at least one material selected from the group consisting of expanded polytetrafluoroethylene, polypropylene, polyethylene, and polyester.

14. The filter of claim 1, wherein said at least one first filter media comprises an electret filter media.

15. The filter of claim 1, wherein said at least one second filter media comprises at least one material selected from the group consisting of papers, membranes, nonwovens, scrims, and cast polymeric membranes.

16. The filter of claim 1, wherein said at least one second filter media comprises at least one material selected from the group consisting of expanded polytetrafluoroethylene, polypropylene, polyethylene, and polyester.

17. The filter of claim 1, wherein said at least one second filter media comprises an electret filter media.

18. The filter of claim 1, further comprising a gasket attached to said filter for sealing the enclosure with the filter.

19. The filter of claim 1, wherein said rigid frame includes a venturi within said chamber.

20. The filter of claim 1, wherein said rigid frame further comprises a vane adapted for deflecting airflow within the chamber.

21. The filter of claim 1, further comprising an attachment means for attaching said filter to said enclosure, the attachment means selected from the group consisting of an adhesive, a drop-in-place assembly, a lock-in-place assembly, and a pressure fit gasket assembly.

22. A method for cleaning a gas or fluid prior to entry of the gas or fluid into an enclosure, the method comprising the steps of:
(i) providing the filter of claim 1,
(ii) attaching said filter to a surface of the enclosure proximal to an inlet to the enclosure, said filter in fluid communication with the inlet to the enclosure,
(iii) providing a fluid pump system proximal and in fluid communication with the enclosure,
(iv) allowing a gas or fluid to be drawn through the inlet thereby drawing the gas or fluid through the filter, the method thereby cleaning the gas or fluid prior to entry into the enclosure.
